(19) United States
(12) Patent Application Publication
(10) Pub. No.: US 2005/0046183 A1
(43) Pub. Date: Mar. 3, 2005

(54) Coupler for flexible hose sections

(76) Inventors: Donald Adams, Saskatoon (CA); James Yausie, Saskatoon (CA); Paul Funk, Saskatoon (CA); Robert Kallio, Saskatoon (CA)

Correspondence Address: STITES & HARBISON, PLLC, 400 W MARKET ST, SUITE 1800, LOUISVILLE, KY, 40202-3352, US

(21) Appl. No.: 10/653,734

(22) Filed: Sep. 2, 2003

(51) Int. Cl. F16L 31/00

(52) U.S. Cl. 285/260

(57) ABSTRACT

A flexible air hose comprises a plurality of hose sections, each having at one end a female portion and at an opposite end a male portion coupled inside the female portion of an adjacent hose section. A loop coupling fastener is attached to an inside surface of the female portion, and a corresponding area of an outside surface of the male portion. A single slit extends from an end edge of the female portion of the hose section longitudinally along the hose section such that the female portion can be opened along the slit to facilitate positioning the male portion inside the female portion. A flap can be provided to cover the slit, and extend past the slit end to reduce air leakage. A wear strip can be wrapped around the hose.

This invention is in the field of flexible hoses and ducts used to conduct air and the like, and in particular couplers for joining such hose sections.

### BACKGROUND

Ventilation hoses are well known in many industries for conducting air from one place to another. For example, in mining and underground tunneling, flexible hose moves air over long distances to the rock face where men and equipment are working. The hose used must be durable and coupling mechanisms airtight to maximize overall efficiency.

In aviation, flexible air hoses are connected to aircraft during loading and unloading or when an aircraft is parked for extended periods. The hoses allow the aircraft engines to be turned off and maintain a constant temperature inside the aircraft by conducting cool or heated air. The hoses used arc generally insulated to reduce costs. Furthermore, the hose and couplings used in this application are again designed to be airtight, thus preventing air from escaping for similar reasons of efficiency and economy.

These aircraft air hoses are typically fabric that lies flat until pressurized by air from the supply unit. The hose comes in sections of varying length so that a hose for a particular site can be made up by connecting a suitable number and length of hose sections. The couplers for connecting the hose sections are typically zippers or zippers combined with hook and loop, in both cases these zipper style couplers are difficult to connect, and subject to breakage. Such a zipper and hook and loop fastener coupler is disclosed in U.S. Pat. No. 6,286,876 to Jasperse et al.

Hook and loop fasteners consist of a hook element and a loop element which engage each other when pressed together. Both zippers and hook and loop fasteners are well known for use in connecting flexible hose sections in mining and underground tunneling. With hook and loop fasteners, typically a female end portion of a hose section has one element of the hook and loop fastener attached to the inside surface thereof, and a male end portion has the other element attached to the outside surface thereof. The male end portion is inserted into the female end portion to engage the two elements to secure the sections to each other. Actually making this coupling is problematic, since the elements on each section grab each other when the male end is inserted, resisting moving the elements into a proper relationship with respect to each other.

U.S. Pat. No. 5,368,341 to Larson discloses a coupler for use with aircraft air hoses using a hook and loop fastener in a particular manner to overcome the problem of properly positioning the coupled hose ends. A first end of each hose section has a pair of slits, one on each side when laid flat such that a pair of flaps is formed, each flap having a hook or loop fastener surface on the inside thereof. To connect the sections, the upper flap is raised to expose the inside of the bottom flap, and the opposite second end, having a corresponding loop or hook fastener surface on the outside thereof is laid flat on the exposed bottom flap to engage the hook and loop fastener, and the upper flap is then pressed down to engage hook and loop fastener on the top of the second end. While the Larson coupler does provide a convenient seal, air can leak out of the inner end of each slit where the inside hose section ends.

U.S. Pat. No. 6,443,499 to Jenum discloses a coupler where ends of adjacent hose sections are not inserted one into the next, but are simply butted up against each other. A cover is attached over the joint between the sections with a hook and loop fastener. For satisfactory operation the ends must be carefully aligned to minimize the gap between the hose sections. As the adjacent ends are not inserted in a male/female relationship, air does not flow smoothly through the couplings on the assembled air hose.

It is typically only when replacing a damaged hose section that the couplers must be disconnected and reconnected. During use, these aircraft air hoses are simply dragged across the tarmac for connection to the aircraft, and then dragged back out of the way when disconnected, then back again for the next aircraft. This dragging causes wear to the surface of the hose, and eventually one or more sections of the hose are damaged to the extent that they must be replaced. The hose of Jasperse et al. is directed to providing a more durable hose for use in aircraft applications.

It is known to provide a wear strip spiraled about the outer surface of hoses such that the wear strip is in contact with the ground rather than the outer surface of the hose, thereby extending the life of the hose. Conventionally these wear strips are sewn into the fabric of the hose and so some air inevitably leaks from the needle holes made during the sewing operation, reducing efficiency of the air transfer.

### SUMMARY OF THE INVENTION

It is an object of the present invention to provide an air hose made up from hose sections using a coupling that overcomes problems in the prior art. It is a further object of the present invention to provide such a coupling and a method of coupling hose sections that reduces air leakage, and is still convenient to use.

It is a further object of the present invention to provide such a coupling and method using a hook and loop fastener for convenience of use.

The invention provides, in one embodiment, a flexible air hose apparatus comprising a plurality of hose sections, each hose section having at one end a female portion and at an opposite end a male portion coupled inside the female portion of an adjacent hose section. A first element of a hook and loop coupling fastener is attached to an inside surface of the female portion, and a corresponding second element of the hook and loop coupling fastener is attached to an outside surface of the male portion and engages the first element of the hook and loop coupling fastener. A single slit extends from an end edge of the female portion of the hose section longitudinally along the hose section to a slit end, and the end edge of the female portion is contiguous from one side of the slit to an opposite side of the slit such that the female portion can be opened along the slit to facilitate positioning the male portion inside the female portion.

The present invention provides, in a second embodiment, a method for coupling a plurality of hose sections together to form a flexible air hose. The method comprises providing a female portion at one end each hose section and a male portion at an opposite end of each hose section; attaching a first element of a hook and loop coupling fastener to an inside surface of the female portion, and attaching a corresponding second element of the hook and loop coupling fastener to an outside surface of the male portion; providing a single slit extending from an end edge of the female portion of the hose section longitudinally along the hose section to a slit end, and maintaining the end edge of the female portion contiguous from one side of the slit to an opposite side of the slit; opening the female portion by spreading the slit; inserting the male portion of an adjacent hose section into the female portion such that the first and second portions of hook and loop coupling fastener are substantially aligned; and pressing the female portion against the male portion to engage the first element of the hook and loop coupling fastener to the second element of the hook and loop coupling fastener while aligning the slit.

The slit allows the female portion to be spread open to facilitate the insertion of the male portion, but there is only one slit so air leakage is reduced. A flap can be provided to cover the slit, or the male portion can extend past the slit in order to reduce leakage. Air pressure inside the hose will press the male portion against the inside of the female S portion to provide a seal that could be satisfactory for some applications. The elements of the hook and loop coupling fastener can be arranged on the male and female portions in various configurations, depending on the application, air pressure carried, and the like. A wear strip comprising a solid raised portion can be wrapped around the hose sections to extend their life.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of an embodiment of the invention where the hose sections are laid flat for coupling;

FIG. 2 is a top view of an embodiment of the invention with the hose sections adjacent to each other and laid flat for coupling;

FIG. 3 is a top view of the embodiment of FIG. 2 where the hose sections are coupled together to form an air hose;

FIG. 4 is a top view of an alternate embodiment of the invention with the hose sections adjacent to each other and laid flat for coupling, and including a flap for sealing the slit;

FIG. 5 is a top view of the embodiment of FIG. 4 where the hose sections are coupled together to form an air hose, and the flap is open;

FIG. 6 is a top view of the embodiment of FIG. 2 where the hose sections are coupled together to form an air hose, and the flap is closed;

FIG. 7 is a top view of another alternate embodiment of the invention with the hose sections adjacent to each other and laid flat for coupling;

FIG. 8 is a top view of the embodiment of FIG. 7 where the hose sections are coupled together to form an air hose;

FIG. 9 is a cross-sectional schematic view of a wear strip of the invention.

### DETAILED DESCRIPTION OF THE ILLUSTRATED EMBODIMENTS

FIG. 1 illustrates a plurality of hose sections 2, each hose section 2 having, at one end a female portion 4 and at an opposite end a male portion 6. As illustrated in FIG. 4, the male portion of one hose section 2 is coupled inside the female portion 4 of an adjacent hose section 2 to form a flexible hose apparatus 1.

A first element 8 of a hook and loop coupling fastener 10 is attached to an inside surface of the female portion 4, and a corresponding second element 9 of the hook and loop coupling fastener 10 is attached to an outside surface of the male portion 6. FIG. 3 illustrates schematically the first and second elements 8, 9 engaging to form the hook and loop coupling fastener 10. One of a hook or a loop element is located as the first element 8, and the other as the second element 9.

A single slit 12 extends from the end edge 14 of the female portion 4 longitudinally along the hose section 2 to a slit end 16. The balance of the end edge 14 of the female portion 4 is unbroken and contiguous from one side of the slit 12 to an opposite side of the slit 12. Thus there is only one area in the coupling of the invention where air can leak out, as opposed to the prior art hook and loop fastener comprising two slits.

In the embodiment illustrated in FIGS. 1-4, the first element 8 of the hook and loop coupling fastener 10 extends from substantially the end edge 14 of the female portion 4 to a coupling terminus 15 part way along the slit 12. The male portion 6 is inserted into the female portion 4 such that the end edge 18 of the male portion 6 is located between the coupling terminus 15 and the slit end 16. The area of the inside of the female portion 4 covered by the first element 8 corresponds substantially to the area of the outside of the male end 6 covered by the second element 9, and the end portion 19 of the male portion 6 is bare of the second element 9 of hook and loop coupling fastener 10.

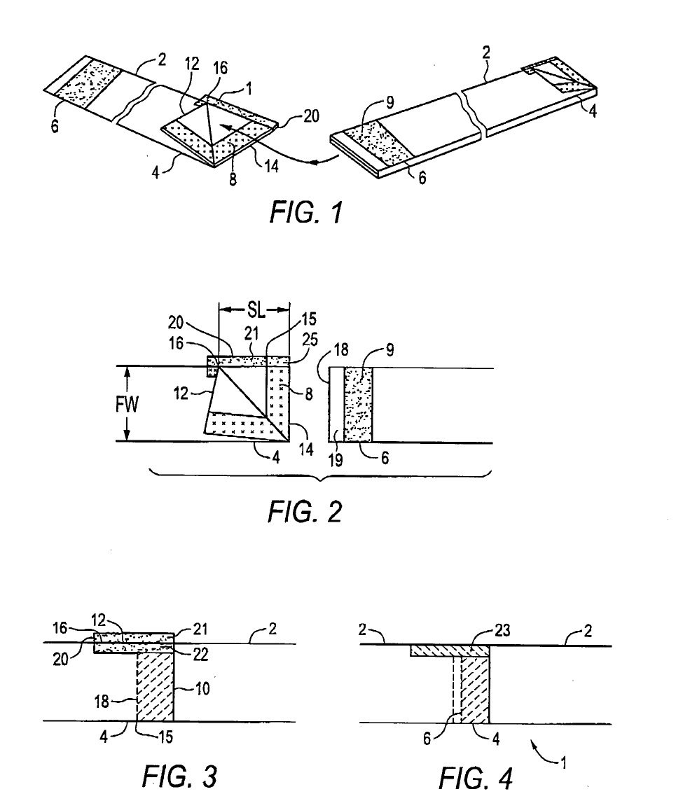

The female portion 4 has a flat width FW when laid flat as in FIG. 2, and for ease of coupling the slit 12 has a length SL such that the slit end 16 is located a distance that is more than one half of the flat width FW from the end edge 14 of the female portion 4. A shorter slit will offer some improvement in ease of coupling, however it is contemplated that a slit length SL of one half to three quarters of the flat width FW will be generally used in practice.

Thus in the embodiment of FIGS. 1-4 the first and second elements 8, 9 of the hook and loop coupling fastener 10 are in a narrow band at the end of the female portion 4. The slit 12 extends considerably farther along the female portion 4 than the hook and loop coupling fastener 10 such that when the female portion 4 is spread open along the slit, it is relatively easy to insert the male portion 6 to a midpoint of the slit 12 where the end edge thereof is between the coupling terminus 15 and the slit end 16. The great majority of the second element 8 is exposed when the female portion 4 is spread open along the slit 12 as illustrated in FIG. 2, such that only a minor amount of tucking is required to properly position the male portion 6 inside the opened female portion 4.

The hook and loop elements of the hook and loop coupling fastener 10 grab each other during the positioning process such they must be disengaged for correction of positioning. The less the area of hook and loop coupling fastener 10, the more easily the coupling can be accomplished.

To prevent air leakage in the embodiment of FIGS. 1-4, a flap 20 is attached to the outside surface of the female portion 4 along a first side of the slit 12. A first element 21 of a hook and loop flap fastener 23 is attached to an inner face 25 of the flap 20, and a second element 22 of the hook and loop flap fastener 23 is attached to the outside surface of the female portion 4 along an opposite second side of the slit 12.

The flap 20 is oriented such that the first element 21 of the hook and loop flap fastener 23 on the inner face 25 of the flap 20 can be pressed against the second element 22 of the hook and loop flap fastener 23 to cover the slit 12, as illustrated in FIG. 4. The illustrated flap 20 can be incorporated into any of the other illustrated embodiments as well where further security of sealing is desired. The illustrated flap 20 and the second element 22 of the hook and loop coupling fastener 23 extend from the end edge 14 of the female portion 4 beyond the slit end. By extending the flap 20 and hook and loop flap fastener 23 beyond the slit end 16, better sealing is provided. In prior art couplings with two slits, the flap 20 ends at the slit end 16, and the end edge 18 of the male portion 6 is also located at the slit end 16. Air leakage occurs at this point through the end of each of the pair of slits in the prior art since there is essentially a hole at this point where the flap, slit, and male portion meet.

By reducing the number of slits to one in the present invention, this air leakage is reduced by one half. By extending the flap 20 beyond the slit end 16, leakage is further reduced. Alternatively or in addition, the male portion 6 may also be extended past the slit end 16, as illustrated in the embodiment of FIGS. 7 and 8.

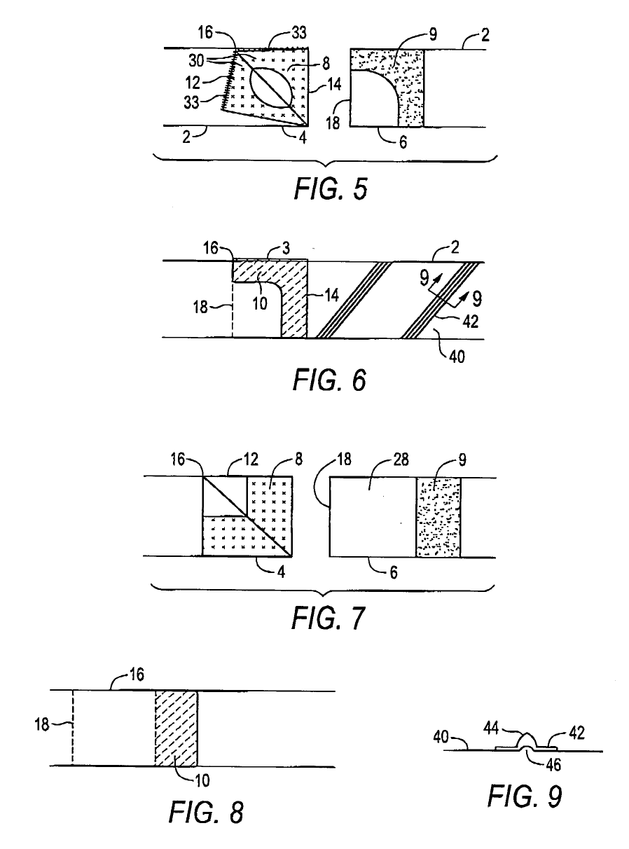

In the embodiment of FIGS. 5 and 6, to facilitate the ease of coupling, the first element 8 of the hook and loop coupling fastener 10 extends from the end edge 14 to the slit end 16 only along first and second portions 30 of the inside surface of the female portion 4 on each side of the slit 12. Farther away from the slit 12, a substantial portion of the hook and loop coupling fastener 10 is removed, making it easier to position the male and female portions 4, 6 properly with respect to each other since there is less hook and loop fastener material to maneuver, as discussed above.

Thus in the embodiment of FIGS. 5 and 6 the hook and loop coupling fastener 10 seals the slit 12 by providing an engaged hook and loop fastener adjacent to both sides of the slit 12. At the same time, a sufficiently strong coupling is provided to prevent the hose sections 2 from separating when conducting pressurized air in some instances. A zip fastener 33 is also illustrated to further secure the coupling against leakage and separation.

FIGS. 8 and 9 illustrate an alternate embodiment wherein the male portion 6 extends into the female portion 4 beyond the slit end 16, and an end portion 28 of the male portion 4 has an outer surface that is bare of the second element 9 of the hook and loop coupling fastener 10, As illustrated the first and second elements 8, 9 form a hook and loop coupling fastener 10 that ends at a midpoint of the slit 12, similar to the embodiment of FIGS. 1-4. Contrary to the embodiment of FIGS. 1-4, the end edge 18 of the male portion 6 extends a substantial distance past the slit end 16. Air pressure inside the hose apparatus 1 will press the male portion 6 against the inside of the female portion 4 to provide a seal that could be satisfactory for some applications providing. A flap or zipper could be added as well to reduce leakage further.

A typical application will see the air hose apparatus 1 adapted at one end thereof for attachment to a pressurized air supply at an airport gate, and adapted at an opposite end thereof for releasable attachment to an aircraft ventilation system. Pressures in such an application are typically about one pound per square inch.

FIG. 5 illustrates a wear strip 42 attached around a circumference of an outside surface 40 of a hose section 2 by welding. Adhesives could also be used if desired or convenient in a particular application. In this way no holes are made in the hose section 2, as is the case with sewing, and so air leakage is reduced. As illustrated in FIG. 9, the wear strip 42 comprises a raised central portion comprising a solid bumper strip 44 with a hollow central portion 46 under the solid bumper strip 44. The solid bumper strip 44 provides for longer wear than prior art wear strips where the strip is made simply by forming a strip of plastic of constant thickness into a strip with a raised bump in the middle. The thin plastic wears out quickly when dragged across a rough surface such as an airport tarmac.

In operation, the method for coupling a plurality of hose sections 2 together to form a flexible air hose apparatus 1 comprises opening the female portion 4 by spreading the slit 12, inserting the male portion 6 of an adjacent hose section 2 into the female portion 4 such that the first and second portions 8, 9 of the hook and loop coupling fastener 10 are substantially aligned, and pressing the female portion 4 against the male portion 6 to engage the first element 8 of the hook and loop coupling fastener 10 to the second element 9 of the hook and loop coupling fastener 10 while aligning edges of the slit 12. This will most conveniently be accomplished by laying the hose sections 2 flat adjacent one another, as illustrated.

In the embodiment comprising a flap 20, the inner face 25 of the flap 20 is moved such that the first element 21 of the hook and loop flap fastener 23 engages the second element 22 of the hook and loop flap fastener 23 to cover the slit 12 and reduce air leakage.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A flexible air hose apparatus comprising:
a plurality of hose sections, each hose section having at one end a female portion and at an opposite end a male portion coupled inside the female portion of an adjacent hose section;
a first element of a hook and loop coupling fastener attached to an inside surface of the female portion, and a second element of the hook and loop coupling fastener attached to a corresponding area of an outside surface of the male portion and engaging the first element of the hook and loop coupling fastener;
a single slit extending from an end edge of the female portion of the hose section longitudinally along the hose section to a slit end, the end edge of the female portion contiguous from one side of the slit to an opposite side of the slit, such that the female portion can be opened along the slit to facilitate positioning the male portion inside the female portion.

2. The apparatus of claim 1 further comprising a flap operative to cover the slit.

3. The apparatus of claim 2 wherein:
the flap is attached to the outside surface of the female portion along a first side of the slit;
a first element of a hook and loop flap fastener is attached to an inner face of the flap;
a second element of the hook and loop flap fastener is attached to the outside surface of the female portion along an opposite second side of the slit;
wherein the flap is oriented such that the first element of the hook and loop flap fastener on the inner face of the flap can be pressed against the second element of the hook and loop flap fastener to cover the slit.

4. The apparatus of claim 3 wherein the flap and the first and second elements of the hook and loop flap fastener extend from the end edge of the female portion beyond the slit end.

5. The apparatus of claim 4 wherein the first element of the hook and loop coupling fastener extends from substantially the end edge of the female portion to a coupling terminus part way along the slit.

6. The apparatus of claim 5 wherein the end edge of the male portion is located between the coupling terminus and the slit end.

7. The apparatus of claim 6 wherein an end portion of the male portion is bare of the second element of hook and loop coupling fastener.

8. The apparatus of claim 1 wherein the male portion extends into the female portion beyond the slit end.

9. The apparatus of claim 1 further comprising a zip fastener operative to close the slit.

10. The apparatus of claim 1 wherein each female portion has a flat width when laid flat, and wherein the slit end is located a distance greater than one half of the flat width from the end edge of the female.

11. The apparatus of claim 1 wherein the first element of the hook and loop coupling fastener extends from the end edge of the female portion along at least first and second portions of the inside surface of the female portion on each side of the slit to substantially the slit end, and wherein the second element of the hook and loop coupling fastener substantially covers a corresponding outside surface area of the male portion.

12. The apparatus of claim 11 the male portion extends into the female portion to at least the slit end.

13. The apparatus of claim 1 adapted at a first end thereof for attachment to a pressurized air supply at an airport gate, and adapted at an opposite second end thereof for releasable attachment to an aircraft ventilation system.

14. The apparatus of claim 1 further comprising a wear strip attached around a circumference of an outside surface of at least one hose section by welding.

15. The apparatus of claim 14 wherein the wear strip comprises a raised central portion comprising a solid bumper strip.

16. The apparatus of claim 15 wherein the wear strip comprises a hollow central portion under the solid bumper strip.

17. A method for coupling a plurality of hose sections together to form a flexible air hose, the method comprising:
providing a female portion at one end each hose section and a male portion at an opposite end of each hose section;
attaching a first element of a hook and loop coupling fastener to an inside surface of the female portion, and attaching a corresponding second element of the hook and loop coupling fastener to an outside surface of the male portion;
providing a single slit extending from an end edge of the female portion of the hose section longitudinally along the hose section to a slit end, and maintaining the end edge of the female portion contiguous from one side of the slit to an opposite side of the slit;
opening the female portion by spreading the slit;
inserting the male portion of an adjacent hose section into the female portion such that the first and second portions of hook and loop coupling fastener are substantially aligned; and
pressing the female portion against the male portion to engage the first element of the hook and loop coupling fastener to the second element of the hook and loop coupling fastener while aligning the slit.

18. The method of claim 17 further comprising covering the slit with a flap.

19. The method of claim 18 wherein covering the slit comprises:
providing a flap attached to the outside surface of the female portion along a first side of the slit;
providing a first element of a hook and loop flap fastener attached to an inner face of the flap;
providing a second element of the hook and loop flap fastener attached to the outside surface of the female portion along an opposite second side of the slit;
moving the inner face of the flap such that the first element of the hook and loop flap fastener engages the second element of the hook and loop flap fastener to cover the slit.

20. The method of claim 19 wherein the flap and hook and loop flap fastener extend beyond the slit end, thereby preventing air from escaping through an end portion of the slit.

21. The method of claim 17 further comprising closing the slit with a zip fastener.

22. The method of claim 17 further comprising attaching a wear strip around a circumference of an outside surface of at least one hose section by one of adhesing and welding.

23. The method of claim 21 wherein the wear strip comprises a raised central portion comprising a solid bumper strip, and a hollow central portion under the solid bumper strip.
